(19) United States
(12) Patent Application Publication
(10) Pub. No.: US 2006/0201288 A1
(43) Pub. Date: Sep. 14, 2006

(54) Swing-type wrench

(76) Inventor: Siou Yi Chen, Taichung County (TW)

Correspondence Address: CHARLES E. BAXLEY, ESQ., 90 JOHN STREET, THIRD FLOOR, NEW YORK, NY, 10038, US

(21) Appl. No.: 11/075,571

(22) Filed: Mar. 9, 2005

(51) Int. Cl. B25B 23/16; B25B 13/00; B25G 1/00

(52) U.S. Cl. 81/177.8; 81/177.7; 81/124.7

(57) ABSTRACT

A swing-type wrench includes a handle, a drive head pivotally mounted on a first end of the handle, and an engaging member secured on the handle and having a substantially polygonal-shaped cross-sectional outer periphery. Thus, the engaging member engages an aid tool, such as an open-ended spanner or the like, so that the user can hold the handgrip of the handle and the aid tool to facilitate rotation of the handle so as to rotate the driving stud of the drive head easily and conveniently, thereby saving the manual work, and thereby facilitating the user operating the driving stud of the drive head to rotate a workpiece, such as a bolt, a nut or the like.

### BACKGROUND OF THE INVENTION

1. Field of the Invention

The present invention relates to a wrench, and more particularly to a swing-type wrench having an angle adjustable function.

2. Description of the Related Art

A conventional swing-type wrench in accordance with the prior art shown in FIG. 12 comprises a handle 10 having a first end provided with a substantially U-shaped pivot ear 11 and a second end provided with a handgrip 15, and a drive head 20 pivotally mounted on the pivot ear 11 of the handle 10 to adjust an angle between the drive head 20 and the handle 10 and having an end face provided with a square driving stud 25. The first end of the handle 10 has an elongated slit 12 extended from the pivot ear 11 to the mediate portion of the handle 10. An urging bolt 13 is screwed into the handle 10 and extended through the elongated slit 12 of the handle 10 to control a spacing of the elongated slit 12 so as to adjust the clamping force of the pivot ear 11 of the handle 10 applied on the drive head 20.

However, when the driving stud 25 of the drive head 20 is moved to be in line with the axial axis of the handle 10 due to the requirement of the working environment, a user cannot hold the handgrip 15 to rotate the handle 10 easily, thereby greatly wasting the user's manual work, and thereby causing inconvenience to the user when rotating the handgrip 15 to drive the driving stud 25 of the drive head 20 to rotate a workpiece, such as a bolt, a nut or the like.

### SUMMARY OF THE INVENTION

The present invention is to mitigate and/or obviate the disadvantage of the conventional wrench.

The primary objective of the present invention is to provide a swing-type wrench having an angle adjustable function.

Another objective of the present invention is to provide a wrench, wherein the force arm length of the handle is increased by provision of the engaging member, so that a user can rotate the handle easily and conveniently.

A further objective of the present invention is to provide a wrench, wherein the engaging member engages an aid tool, such as an open-ended spanner or the like, so that the user can hold the handgrip of the handle and the aid tool to facilitate rotation of the handle so as to rotate the driving stud of the drive head easily and conveniently, thereby saving the manual work, and thereby facilitating the user operating the driving stud of the drive head to rotate a workpiece, such as a bolt, a nut or the like.

In accordance with the present invention, there is provided a wrench, comprising:

a handle;

a drive head pivotally mounted on a first end of the handle; and

an engaging member secured on the handle and having a substantially polygonal-shaped cross-sectional outer periphery.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a wrench in accordance with the preferred embodiment of the present invention;

FIG. 2 is an exploded perspective view of the wrench as shown in FIG. 1;

FIG. 3 is a schematic operational view of the wrench as shown in FIG. 1 in use;

FIG. 4 is a perspective view of a wrench in accordance with another preferred embodiment of the present invention;

FIG. 5 is an exploded perspective view of the wrench as shown in FIG. 4;

FIG. 6 is a perspective view of a wrench in accordance with another preferred embodiment of the present invention;

FIG. 7 is a schematic operational view of the wrench as shown in FIG. 6 in use;

FIG. 8 is a perspective view of a wrench in accordance with another preferred embodiment of the present invention;

FIG. 9 is a schematic operational view of the wrench as shown in FIG. 8 in use;

FIG. 10 is a perspective view of a wrench in accordance with another preferred embodiment of the present invention;

FIG. 11 is an exploded perspective view of the wrench as shown in FIG. 10;

FIG. 12 is a perspective view of a conventional wrench in accordance with the prior art.

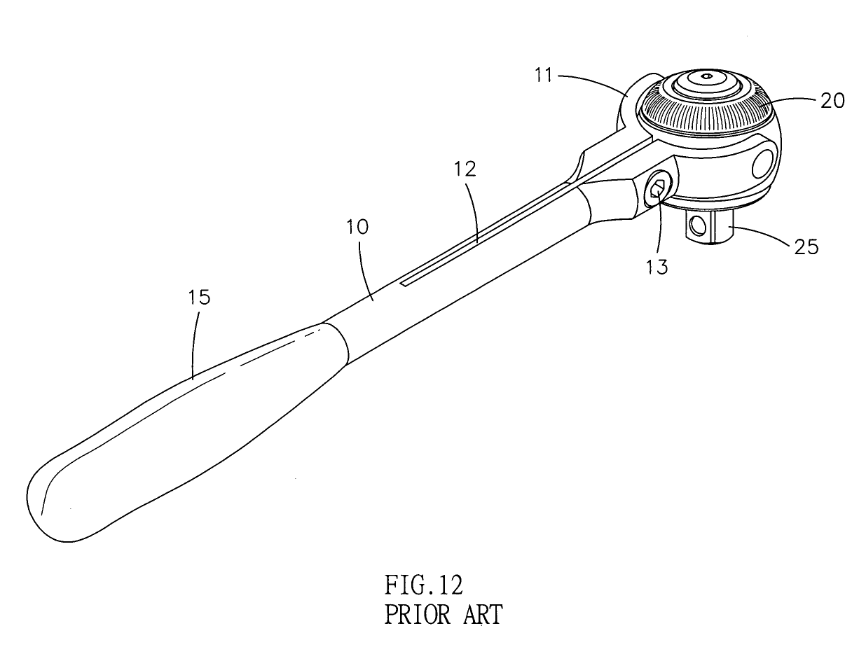

### DETAILED DESCRIPTION OF THE INVENTION

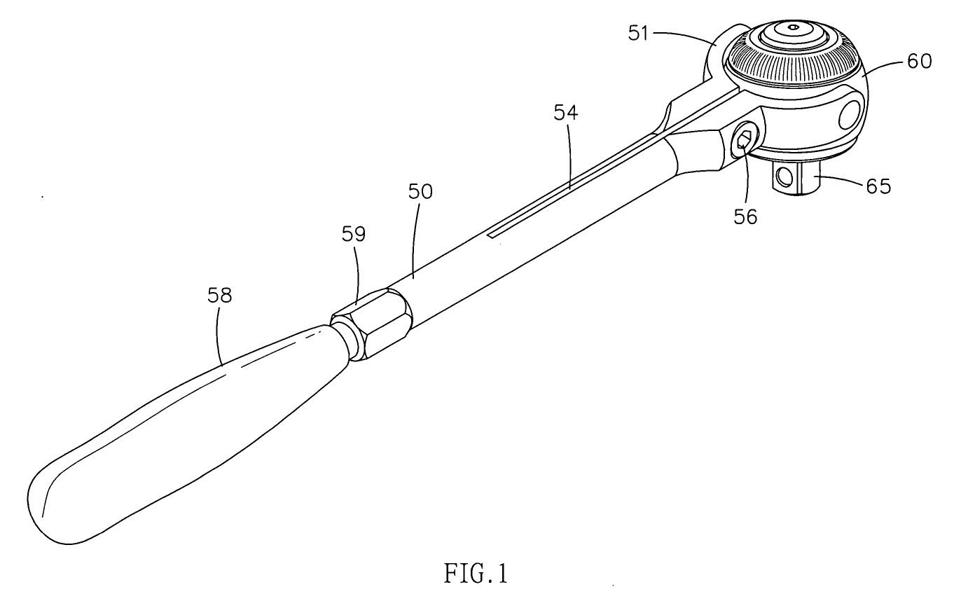

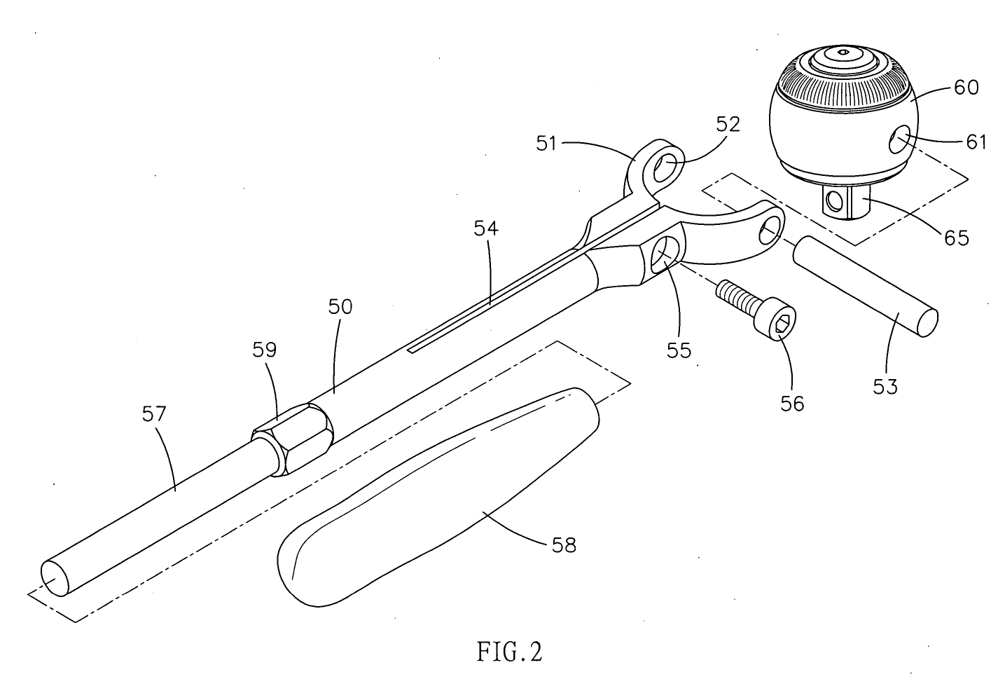

Referring to the drawings and initially to FIGS. 1-3, a wrench in accordance with the preferred embodiment of the present invention comprises a handle 50, a drive head 60 pivotally mounted on a first end of the handle 50, and an engaging member 59 secured on the handle 50 and having a substantially polygonal-shaped cross-sectional outer periphery. Preferably, the engaging member 59 is integrally formed with the handle 50 and located on a mediate portion of the handle 50. In addition, the engaging member 59 has a substantially hexagonal cross-sectional outer periphery.

The first end of the handle 50 is provided with a substantially U-shaped arcuate pivot ear 51 having two pivot holes 52, an elongated slit 54 extended from the pivot ear 51 to the mediate portion of the handle 50, and a sunk screw bore 55 extended through the elongated slit 54 and located adjacent to the pivot ear 51. The drive head 60 has a periphery formed with a pivot hole 61 and has an end face provided with a square driving stud 65. A pivot shaft 53 is extended through each of the two pivot holes 52 of the pivot ear 51 of the handle 50 and the pivot hole 61 of the drive head 60, so that the drive head 60 is pivotally mounted on the pivot ear 51 of the handle 50 to adjust an angle between the drive head 60 and the handle 50. An urging bolt 56 is screwed into the sunk screw bore 55 of the handle 50 to control a spacing of the elongated slit 54 of the handle 50 so as to adjust the clamping force of the pivot ear 51 of the handle 50 applied on the drive head 60. The handle 50 has a second end provided with a mounting portion 57 for mounting a handgrip 58.

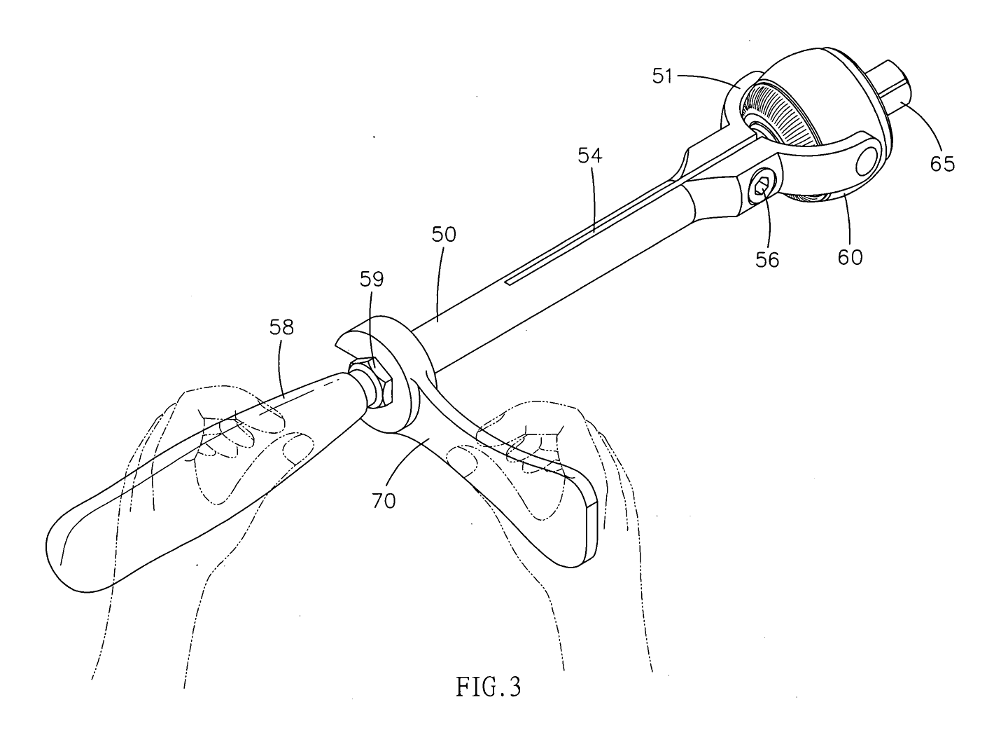

In operation, when the driving stud 65 of the drive head 60 is moved to be in line with the handle 50 as shown in FIG. 3 due to the requirement of the working environment, a user can hold the handgrip 58 of the handle 50 with his one hand and can hold an open-ended spanner 70 with his other hand to engage the engaging member 59 with the open-ended spanner 70 to increase the force arm length of the handle 50, so that by provision of the engaging member 59, the user can hold the handgrip 58 of the handle 50 and the open-ended spanner 70 to facilitate rotation of the handle 50 so as to rotate the driving stud 65 of the drive head 60 easily and conveniently, thereby saving the manual work, and thereby facilitating the user operating the driving stud 65 of the drive head 60. In addition, any two opposite faces of the engaging member 59 have a distance matching a width of the open-ended spanner 70, so that the open-ended spanner 70 engages the engaging member 59 easily and rapidly in an exact manner.

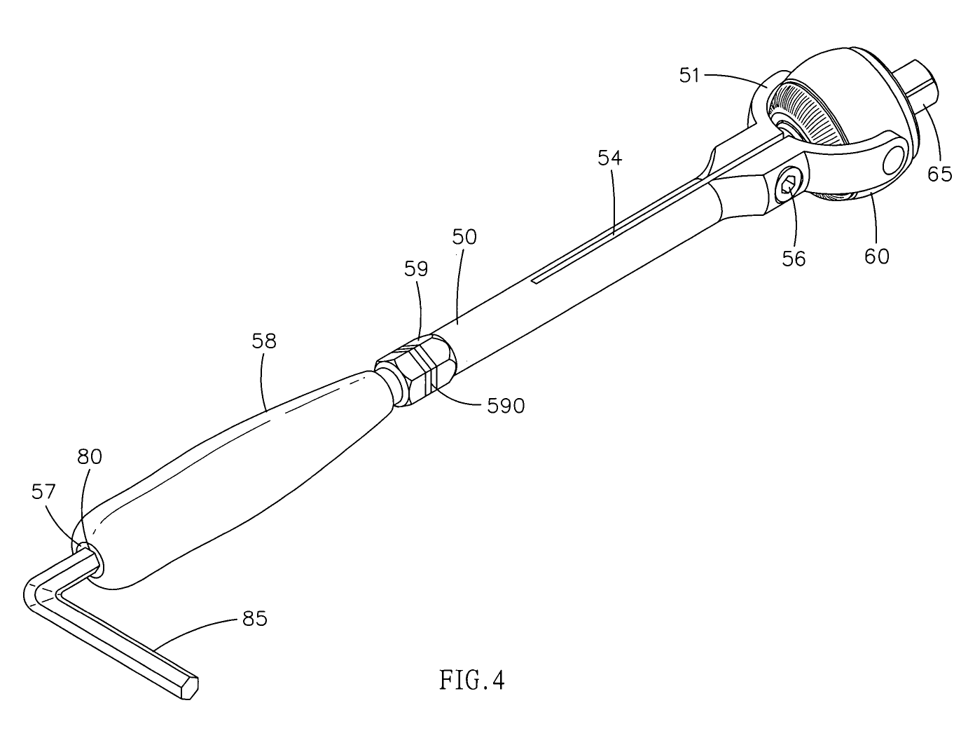

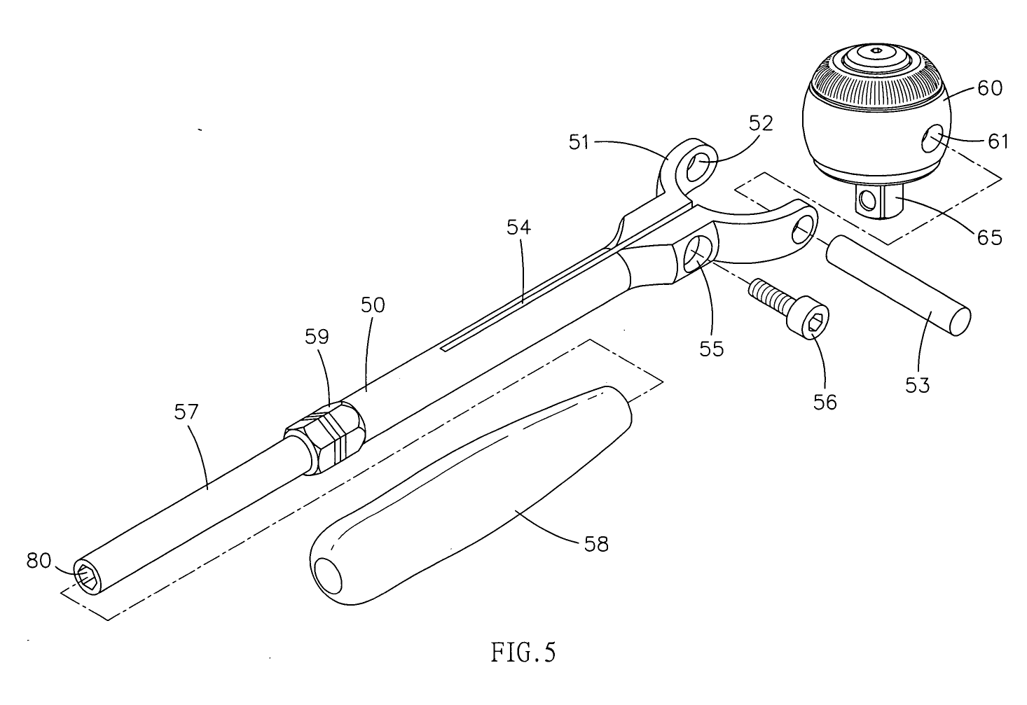

Referring to FIGS. 4 and 5, the engaging member 59 has a surface provided with a plurality of anti-skid stripes 590 to provide an anti-skid effect. In addition, the handle 50 has a distal end formed with a hexagonal hole 80 to receive a hex wrench 85 to facilitate rotation of the handle 50. In addition, the hexagonal hole 80 of the handle 50 is longitudinally extended along an axial direction of the handle 50.

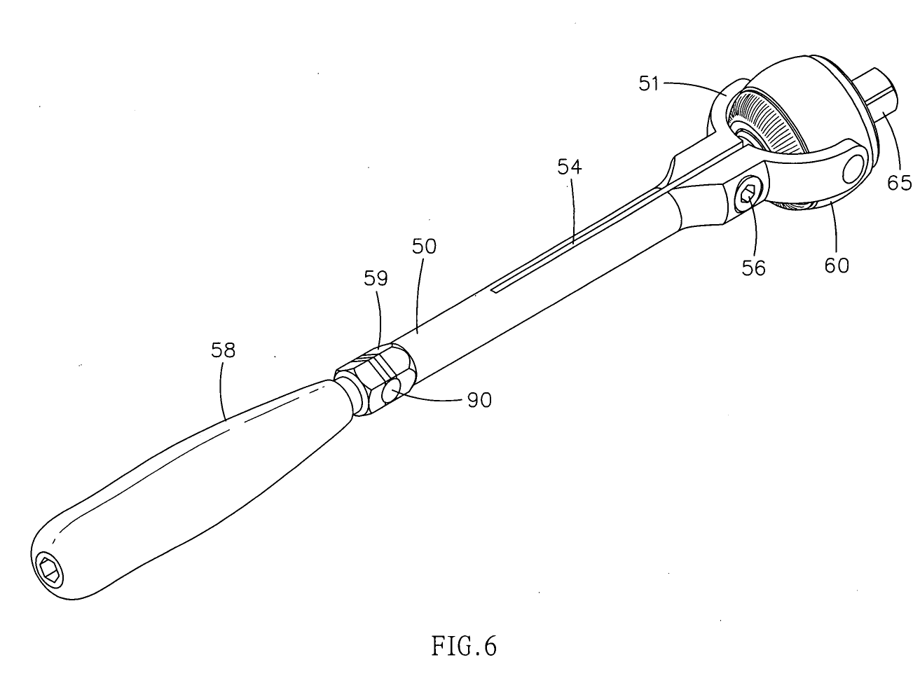

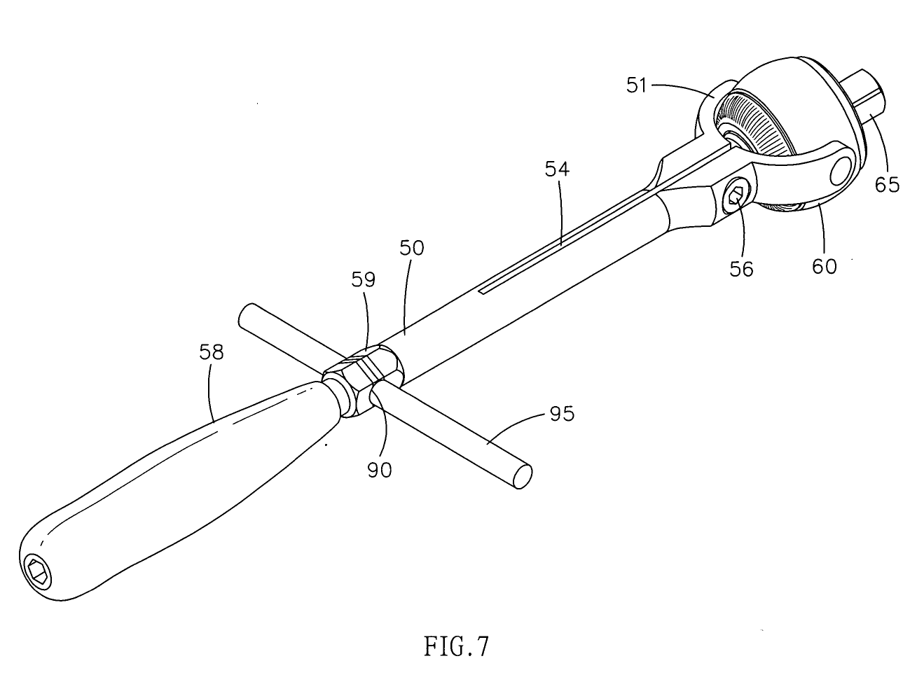

Referring to FIGS. 6 and 7, the engaging member 59 has a mediate portion formed with an insertion hole 90 to allow insertion of an elongated rod 95 to facilitate rotation of the handle 50. In addition, the insertion hole 90 of the engaging member 59 has an axial direction perpendicular to that of the handle 50.

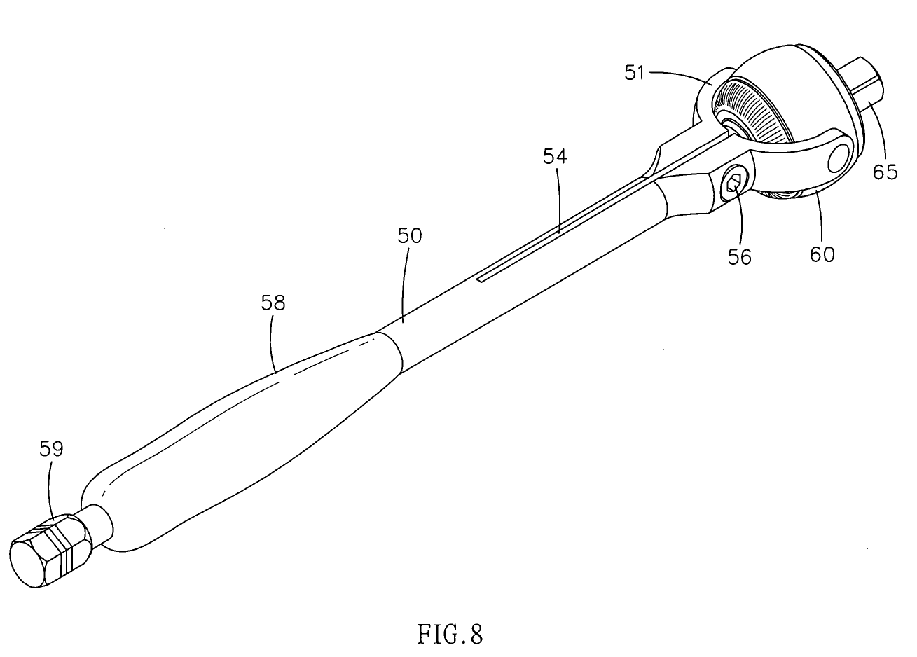

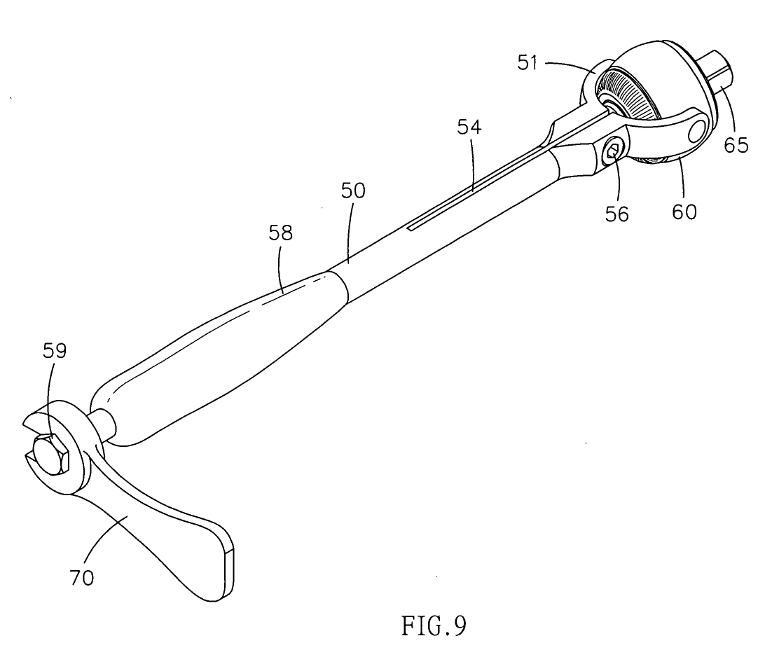

Referring to FIGS. 8 and 9, the engaging member 59 is located on and protruded outward from a distal end of the handle 50.

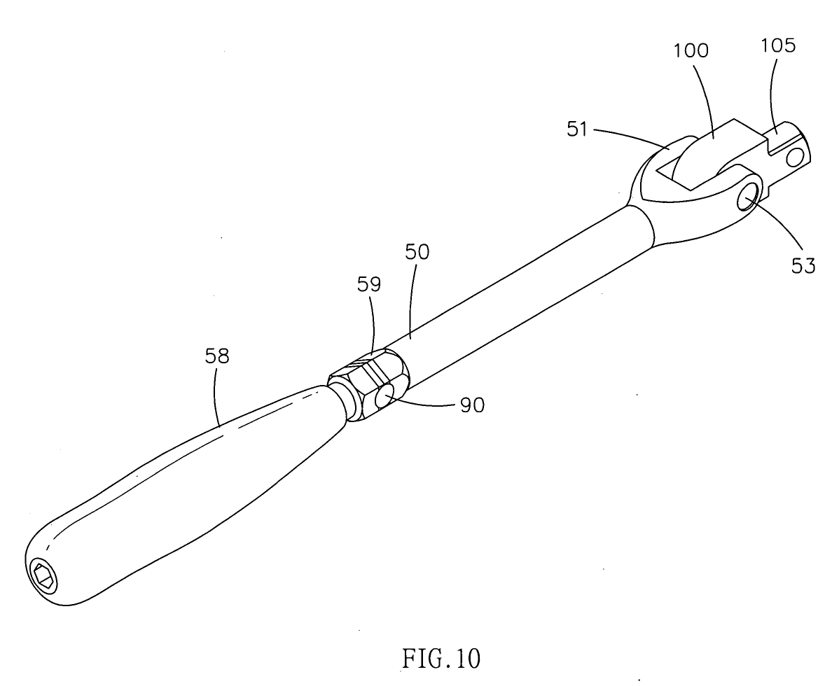

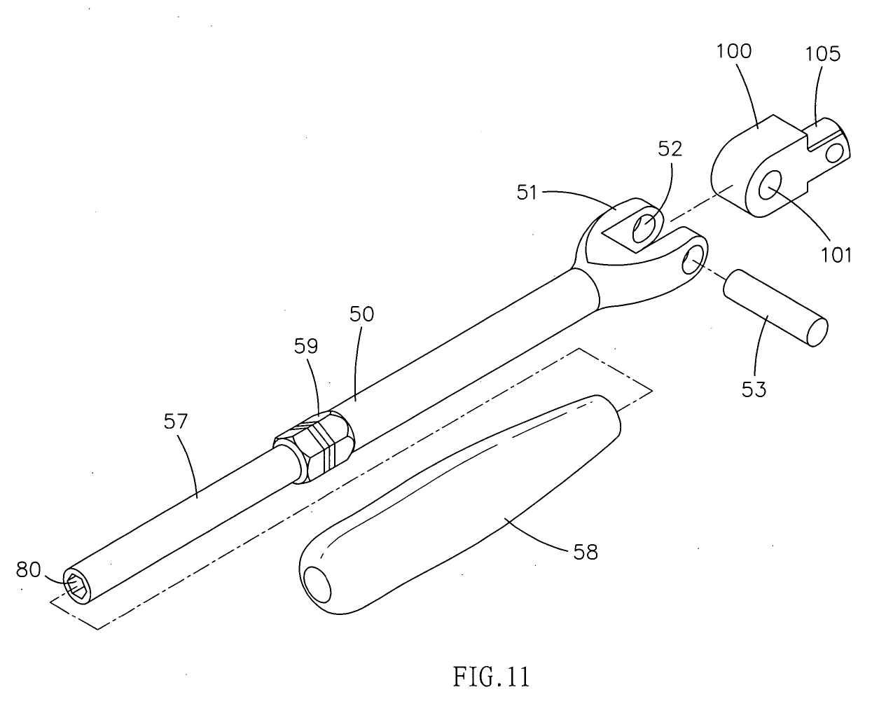

Referring to FIGS. 10 and 11, the drive head 100 pivotally mounted on the pivot ear 51 of the handle 50 and has a first end formed with a pivot hole 101 and a second end integrally formed with a square driving stud 105.

Accordingly, the force arm length of the handle 50 is increased by provision of the engaging member 59, so that the user can rotate the handle 50 easily and conveniently. In addition, the user can hold the handgrip 58 of the handle 50 and the open-ended spanner 70 to facilitate rotation of the handle 50 so as to rotate the driving stud 65 of the drive head 60 easily and conveniently, thereby saving the manual work, and thereby facilitating the user operating the driving stud 65 of the drive head 60 to rotate a workpiece, such as a bolt, a nut or the like.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A wrench, comprising:
a handle;
a drive head pivotally mounted on a first end of the handle; and
an engaging member secured on the handle and having a substantially polygonal-shaped cross-sectional outer periphery.

2. The wrench in accordance with claim 1, wherein the engaging member is integrally formed with the handle.

3. The wrench in accordance with claim 1, wherein the engaging member is located on a mediate portion of the handle.

4. The wrench in accordance with claim 1, wherein the engaging member has a substantially hexagonal cross-sectional outer periphery.

5. The wrench in accordance with claim 1, wherein a user can hold the handgrip of the handle with his one hand and can hold an open-ended spanner with his other hand to engage the engaging member with the open-ended spanner to increase a force arm length of the handle, so that by provision of the engaging member, the user can hold the handgrip of the handle and the open-ended spanner to facilitate rotation of the handle so as to rotate the drive head.

6. The wrench in accordance with claim 5, wherein any two opposite faces of the engaging member have a distance matching a width of the open-ended spanner, so that the open-ended spanner engages the engaging member 59 exactly.

7. The wrench in accordance with claim 1, wherein the engaging member has a surface provided with a plurality of anti-skid stripes to provide an anti-skid effect.

8. The wrench in accordance with claim 1, wherein the handle has a distal end formed with a hexagonal hole to receive a hex wrench to facilitate rotation of the handle.

9. The wrench in accordance with claim 8, wherein the hexagonal hole of the handle is longitudinally extended along an axial direction of the handle.

10. The wrench in accordance with claim 1, wherein the engaging member has a mediate portion formed with an insertion hole to allow insertion of an elongated rod to facilitate rotation of the handle.

11. The wrench in accordance with claim 1, wherein the insertion hole of the engaging member has an axial direction perpendicular to that of the handle.

12. The wrench in accordance with claim 1, wherein the engaging member is located on and protruded outward from a distal end of the handle.

13. The wrench in accordance with claim 1, wherein the drive head has an end integrally formed with a square driving stud.

14. The wrench in accordance with claim 1, wherein the handle has a second end provided with a mounting portion for mounting a handgrip.
